(19) United States
(12) Patent Application Publication
(10) Pub. No.: US 2014/0278688 A1
(43) Pub. Date: Sep. 18, 2014

(54) GUEST MOVEMENT AND BEHAVIOR PREDICTION WITHIN A VENUE

(71) Applicant: DISNEY ENTERPRISES, Inc., Burbank, CA (US)

(72) Inventors: Bart SULLIVAN, Burbank, CA (US); Robert AIELLO, Burbank, CA (US); Anthony APODACA, San Rafael, CA (US); Amber R. A. BROWN, Glendale, CA (US); Jason H. LLOPIS, Burbank, CA (US); Joseph W. MARKS, Glendale, CA (US)

(73) Assignee: DISNEY ENTERPRISES, Inc., Burbank, CA (US)

(21) Appl. No.: 13/835,225

(22) Filed: Mar. 15, 2013

(51) Int. Cl. G06Q 10/06

(52) U.S. Cl. CPC G06Q 10/06312
USPC 705/7.22

(57) ABSTRACT

Techniques are disclosed to predict movement and behavior of a guest within a geographic region. In one embodiment, a map is received that contains locations and further contains routes connecting the locations within the geographic region. A historical data set is received that specifies actions and locations of one or more previous guests with respect to the map. A new data set is received that specifies actions and locations of a current guest within the geographic region. The new data set is correlated with the historical data set. Characteristics of the guest are interpreted based on the correlation, to generate a set of predicted future actions of the guest within the geographic region.

### BACKGROUND

1. Field of the Invention

Embodiments presented herein relate to behavior prediction, and more specifically, to statistical techniques for real-time predictions of guest movement and behavior in a venue.

2. Description of the Related Art

Theme parks operators strive to provide a great guest experience by managing traffic flow to make the park navigable without congestion, managing crowds to provide a sense of community without crowding, and manage wait times for attractions to enable guests to enjoy features of the park other than attractions and lines. One driver of guest experience is the stochastic movement of guests throughout the park. While guests do not move randomly throughout the park, it is difficult for the park operator to predict a path of an individual guest or to predict a collective distribution of guest movement.

As a result of guest movement, one region of a park can become overcrowded, leaving other regions of the park relatively empty. This phenomenon may be caused by a popular attraction, an event, a natural bottleneck caused by the structure of the park, weather, or a simple coincidence of group guest behavior. While park operations may anticipate some areas of congestion (e.g., congestion caused by a popular attraction), park operators often have trouble anticipating when different regions will experience peak attendance and where individual guests will travel.

### SUMMARY

Embodiments of the invention provide techniques for predicting guest movement and behavior in a venue as well as optimizing venue operations. One embodiment includes a method for managing venue operations based on predictions of guest behavior. This method may generally include generating, from historical guest movement data identifying guest locations within the venue, patterns of guest movement within the venue and also include obtaining, for a plurality of current guests visiting the venue, data specifying observed locations of the plurality of current guests within the venue. This method may also include predicting, based on the location data and the patterns of guest movement generated from the historical guest movement data, predicted future locations within the venue for at least some of the plurality of current guests and adjusting venue operations based on the predicted future locations. For example, adjusting venue operations may include at least one of changing staffing levels or assignment, scheduling maintenance, scheduling cleaning, and ensuring product availability or location. In a particular embodiment, the method may further include generating a message delivered to at least one of the plurality of current guests. The message provides an incentive to visit a location within the venue other than the predicted location.

In a particular embodiment, predicting of the predicted future locations within the venue for at least some of the plurality of current guests is performed using approximate string matching.

Another embodiment includes a method for motivating guest behavior within a venue. This method may generally include, for a first entity comprising at least one individual, correlating the entities current actual behavior with past behavior records of other entities to identify correlated past behavior records. This method may also include using the correlated past behavior records, predicting at least one future behavior of the first entity and determining whether the predicted future behavior is consistent with operational goals of the venue. When predicted future behavior is inconsistent with the operational goals, a responsive action is taken. The responsive action may include taking one or more actions selected from a group consisting of: providing a motivation to change the first entities future behavior such that it is different from the predicted behavior and changing some operational characteristic of the venue such that the predicted future behavior is consistent with operational goals of the venue.

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### BRIEF DESCRIPTION OF THE DRAWINGS

The appended drawings illustrate exemplary embodiments of this invention and are not to be considered limiting of its scope, for the invention may admit to other equally effective embodiments.

FIG. 1 is a block diagram of a system configured to improve guest experience in a theme park according to one embodiment.

FIG. 2 is a flowchart depicting a method for predicting future gust locations using approximate string matching, according to one embodiment of the invention.

FIG. 3 is a flowchart depicting a method for predicting movement, according to one embodiment.

FIG. 4 is a flowchart depicting a method for using a generated prediction to alter park logistics or to send an incentive to the guest, according to an embodiment.

FIG. 5 is a conceptual representation of a theme park with locations and routes connecting the locations, according to an embodiment.

FIG. 6 is a conceptual representation similar to FIG. 5 illustrating a trip of a guest through a geographic region, according to an embodiment.

### DETAILED DESCRIPTION

It is desirable for theme park operators to minimize the time park guests spend waiting in line. On a crowded day at a popular theme park attraction, it is not unheard of for guests to wait in line for over an hour for a two-minute ride. These excessive delays can negatively impact the guest experience and, in turn, the theme park revenue. Guests who have to wait in long lines often go on fewer rides, buy fewer products from concessions, and are less likely to return to the park in the future. While park operators provide incentives to alter the flow of guest traffic in the park, it is challenging to predict who to provide incentives to, what incentives to provide, and what regions of the park to target using the incentives.

In general, the embodiments disclosed herein describe techniques for predicting movement and behavior of individuals, groups and crowds in a venue, e.g., a shopping mall, sports facility, and regions of the theme park. In one embodiment, a guest's trajectory in a venue is represented as a string of characters p=p₁p₂p₃ . . . pₙ, where pᵢ represents a location such as a ride, restaurant, or shop. Such a trajectory can be computed from a stream of (x, y) locations, as might be computed via GPS, and a database linking locations pᵢ with (x, y) coordinates (see Table 1).

TABLE 1
A database of park locations.

| Place | x | y | location |
|---|---|---|---|
| Teacup Ride | 456 | 732 | p₃₈ |
| Pirate Restaurant | 237 | 344 | p₂₇ |
| Princess Palace | 355 | 901 | p₁₉ |

In such a system, a database of complete exemplar guest trajectories, P, is computed and stored once by instrumenting venue staff or actual guests with a suitable location tracking device, such as a smartphone with GPS, WiFi, or Bluetooth software, and recording their locations as they traverse typical trajectories in a venue. The database P may be scrubbed algorithmically or manually to correct errors and fill in missing location readings.

The database P can be used to predict in real time the future behavior of a guest for which a partial trajectory q=q₁q₂q₃ . . . qₘ is available. Such a partial trajectory q might be computed from various location-sensing technologies, such as GPS on a smartphone, worn RFID tags read by fixed sensors, facial recognition via cameras, or even point-of-sale payment records. Typically, such a trajectory might be incomplete, since all known location-sensing technologies produce incomplete data due to missed or erroneous readings. To address this issue, embodiments of the present invention find the closest match p in the set of exemplar trajectories P for the partial trajectory q. The closest match p can then be used as the basis for predicting the locations that the guest will soon visit. This approach uses approximate or fuzzy string matching, in which a query string, in this case the partial trajectory q, is matched against substrings in a dictionary of strings, in this case the exemplar trajectories p in the database P.

Approximate string matching relies on measurement criteria for similarly between two strings of characters. For example, the similarity of a match can be measured in terms of the number of primitive operations necessary to convert the pattern string into one that matches the query string exactly. This number is called the edit distance between the pattern string and the query string. Examples of primitive operations include:

insertion: cot→coat

deletion: coat→cot

substitution: coat→cost

transposition: coat→caot

A matching algorithm can compute variants of the edit distance by assigning difference costs to these operations in the computation of the edit distance.

Given a specific edit distance, the problem of finding the best database match for a partial trajectory q is formally stated as finding the string pεP such that the edit distance between q and some substring of p is minimized. A brute-force approach would be to compute the edit distance to q for all substrings of all the strings pεP, and then choose the string whose substring results in the minimum distance. This algorithm is described in pseudocode below:

```
string find_best_match(q, P)
string q, P[ ]; /* q is a partial trajectory. P is a set of exemplar
trajectories. */
{
  for edit_dist = 0 to MAX_EDIT_DIST do
  {
    S = gen_strings(q, edit_dist) ; /* Generates set of all strings
    within edit_dist of q. */
    for s ε S do
    {
      for p ε P do
        if s == p then
          return(p) ;
    }
  }
  return(NULL) ;
}
```

However, this approach runs slowly on long strings p, q or when the database P is large. For this reason, more efficient algorithms can used. One such efficient algorithm was developed by Sellers in 1980 (see Sellers, Peter H. (1980). “The Theory and Computation of Evolutionary Distances: Pattern Recognition,” Journal of Algorithms 1(4):359-73, doi:10.1016/0196-6774(80)90016-4), and others have since been developed (see http://en.wikipedia.org/wiki/Approximate_string_matching). Of course, one of ordinary skill in the art will recognize that other suitable string matching algorithms can be used as well.

Once the best match p in the database P of exemplar trajectories is found, it can provide the basis for predicting locations that the guest will visit next. For example, if q=q₁q₂q₃ . . . qₘ is the partial trajectory of a guest and p=p₁p₂p₃ . . . pₙ is the best match from P, let pᵢ . . . pⱼ represent the substring of p that best matches q. Then a good prediction for the next location that the guest will visit is pⱼ₊₁. It will be evident to one skilled in the arts that other predictions can be made on the basis of p.

Note, the embodiment described above relies on locations visited by a guest, but not the transit time taken to travel between locations. To incorporate transit times, the timings of all location readings are taken, both for the exemplar trajectories in P and for the partial trajectory q. These timings are used to introduce a new symbol x into the trajectories. The special symbol x denotes a fixed quantum of transit time, say 1 minute. So for example, the string pᵢxxxpⱼ represents a guest taking 3 minutes between arriving at location pᵢ and arriving at location pⱼ. With the special symbol so used, the approximate trajectory matching algorithm given above can readily incorporate transit times between locations into the approximate trajectory matching, which makes for more accurate predictions of future locations.

Data regarding a guest position is readily collected by a variety of methods such as global positioning system (GPS), radio frequency identification (RFID), personal check-ins, or devices communicating using Bluetooth (or other wireless protocol). As an example, guest location data could be gathered from a GPS receiver in a mobile device located with the guest. An application on a mobile device sends GPS data to the prediction generating application. In another example, guest data could be gathered from RFID input. Guests given an RFID tag, may be observed or otherwise detected by RFID readers placed at known locations. Such readers then report the location of the guest upon reading a tag within range of the reader. This data is string in a database.

Predicting behavior for multiple guests allows the venue operator to identify patterns of guest movement. Once we have this information the operator can adjust venue operations e.g., changing staffing, scheduling maintenance, scheduling cleaning, ensuring stock or product availability. Thus the predictions can be used to improve venue operations. Further, at least in some case, the venue operator can attempt to alter guest behavior in ways that help venue operations or help improve guest experience.

In one embodiment, the prediction generating application outputs the prediction to an incentive application. In turn, the incentive application sends an incentive message to a guest in order to influence or otherwise change the behavior of that guest. Note, while generally discussed using “incentives” in the approaite case, a guest may be given disincentives as well. More generally, the approach for influencing or changing guest behavior may include both things and information that encourage desired behavior and discourage undesired behavior. For example, informing a guest that a particular route will take five minutes longer to reach a particular destination because of an intervening parade or disruption or congestion can provide sufficient disincentive to discourage people from taking that path. Further, while a guest is generally described in reference to a single individual, a guest could refer to groups of individuals (e.g., a family visiting a theme park).

In one embodiment, the incentive application can generate incentives to influence a group to create a more even distribution of guests. Doing so can minimize or reduce the length of lines at popular attractions. For example, if the incentive application determines that an area of the venue is congested and/or a path within a venue has high traffic, then the incentive application can be used to route guests away from the congested or high-traffic area.

In one embodiment, the incentives can include coupons, discounts, suggestions, or return time queue management mechanisms. For example, the incentive can be presented to a guest as a text message with a code to be redeemed for a discount. By providing the incentives, venue operators can influence the flow of traffic in the venue, which in turn can decrease the wait-time in particular areas of the park and at certain attractions.

As another example, a logistics application can evaluate the guest movement predictions and adjust venue operations as appropriate. For example, the total count of guests predicted to be in a given location can be provided to venue staff, such as vendors or ride operators, allowing them to preemptively alter their operation to better accommodate an anticipated influx of guests. For example, the logistics application could warn a fruit vendor that guest traffic is anticipated to increase and instruct the fruit vendor to place more items on display accordingly.

Embodiments described herein can generate predictions even if the new data set is incomplete, also referred to herein as “sparse.” As noted, e.g., the database P may be scrubbed algorithmically or manually to correct errors and fill in missing location readings. For example, assume a guest visits a location but does not swipe a RFID wristband of the reader against the RFID reader provided in the park. Assume further that the guest then swipes the wristband at a subsequent location. In this scenario, the database P includes a string for this guest with the actually observed locations, which may be compared to strings representing other paths. In such a case, even though the string is “missing” a character for the missed location, the overall character string representing the guest's movement can be compared to strings q in database P to find the most correlated string. Such a string can then be used to predict the future location of the guest.

In some embodiments, the prediction generating application output the prediction to venue operators. The park operator could then, for example, use the predictions to coordinate operations with vendors and ride operators. Doing so may improve efficiency of park operations. In other embodiments, the logistics application send instructions to the venue operator to reconfigure the park to better accommodate an anticipated increase or decrease in guest traffic in a given area of the park. The instructions for to the venue operator and the incentives for the guests and more generally referred to herein as recommendations.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIG. 1 is a block diagram illustrating a system 100 for improving guest experience in a venue by predicting actions of a guest, delivering incentives to the guest, and/or sending a message to park operators to affect park operations, according to various embodiments of the invention. The system 100 includes a computer 102. The computer 102 is connected to other computers via a network 130. As shown, the computer 102 is connected to a data store 150 and collection devices (140_{1-N}) through network 130.

The computer 102 generally includes a processor 104 connected via a bus 112 to a memory 106, a network interface device 110, a storage 108, an input device 114, and an output device 116. The computer 102 is generally under the control of an operating system (not shown). Any operating system supporting the functions disclosed herein may be used. The processor 104 is included to be representative of a single CPU, multiple CPUs, a single CPU having multiple processing cores, and the like. Similarly, the memory 106 generally represents a random access memory. The network interface device 110 connects the computer 102 to other computers or mobile devices via the network 130.

The storage 108 provides a persistent storage device. Although the storage 108 is shown as a single unit, the storage 108 can also be a combination of available storage devices, such as disc drives, solid state drives, removable memory cards, optical storage and the like.

The input device 114 generally corresponds to devices for providing input to the computer 102. For example, a keyboard and/or a mouse may be used. The output device 116 may be any device for providing output to a user of the computer 102. For example, the output device 116 may be any conventional display screen or set of speakers. Although shown separately from the input device 114, the output device 116 and input device 114 may be integrated.

As shown, the memory 106 contains guest data 118, a data collection application 120, a prediction generating application 122, an incentive application 124, and a logistics application 126. In one embodiment, the guest data 118 is stored in a database containing a set of locations describing the trajectories of current guests through a venue. Each location in the guest data 118 is derived from the journey or path of an individual guest based on data input from collection device 140ᵢ. As used herein, collection device 140ᵢ refers to any or all of collection devices 140_{1-N}. Further, the data collection application 120 is an application generally configured to manage new guest data received from collection device 140ᵢ. The data collection application 120 receives new guest data from the collection device 140ᵢ and stores the received data in memory, i.e., as the guest data 118. Note elements (e.g., guest data 118) is shown in memory 106 for convenience, as one of ordinary skill in the art will recognize that computing applications move both application instructions and data between memory 106 and storage 108 as needed. For example, storage 108 can include a database P of strings representing guest movement, with individual records being called into memory 106 from storage 108 on demand.

In one embodiment, the data store 150 refers to any entity or device configured to store guest location (and other) data. Similar to the storage 108, the data store 150 can be implemented using a variety of fixed or removable storage devices used to store database P. For example, in one embodiment, the data store 150 is a computer server with a relational database system.

In one embodiment, a database of complete exemplar guest trajectories, the historical data set 128, is computed and stored once by instrumenting venue staff or actual guests with location devices similar to the location devices 140i used for real-time data collection and recording the venue staff or guests as they traverse the venue in habitual ways. The prediction generating application 122 is generally configured to receive data from the data collection application 120 and to use this data to generate a prediction of the next location of a guest in the venue. The prediction generating application 122 correlates guest data 118 to historical data set 128 and uses the correlation to generate a prediction. In one embodiment the correlation is performed using approximate string matching. To do so, the prediction generating application 122 searches the historical data set 128 for a nearest trajectory closely approximating the trajectory stored in guest data 118. The prediction generating application 122 then finds the subsequent location in the nearest trajectory and then generates a prediction based on this subsequent location.

In one embodiment, the prediction generating application 122 passes the prediction to the incentive application 124. The predictions are then used to adjust any aspect of venue operations, including, e.g., changing staffing, scheduling maintenance, scheduling, cleaning, ensuring stock or product availability, and the like.

In a particular embodiment, in additions to adjusting features of venue operation to accommodate predicted guest movement, the system disclosed herein can attempt to influence guest behavior within the venue. For example, the incentive application 124 is an application generally configured to use the prediction to generate an incentive to the guest at the venue.

The targeted incentive is used to attempt influence guest behavior, based on a user configurable set of directives (e.g., to balance guests, to improve underperforming retail sales points, to improve experience by directing guests to available activities or just setting guest expectations by letting guests that appear to be headed to a popular attraction of a wait time for accessing that attraction). For example, if the prediction generating application 122 predicts the guest will travel to region A, but the venue operator wants to increase the number of guests in region B (or decrease traffic on the path to region A), then the incentive application 124 sends the guest a targeted incentive to incentivize the guest to travel to region B, rather than to region A. Depending on the embodiment, the incentive can take the form of a text message providing a coupon, and/or a suggestion that certain areas of the venue are not crowded (or to alert the guest that an predicted area of travel is overcrowded at the moment). However, those skilled in the art will appreciate that the incentive is not limited to these embodiments.

In one embodiment, the prediction generating application 126 provides (or makes available) the prediction to the logistics application 126. The logistics application 126 is generally configured to create instructions or information based on the prediction and send the information or instructions through network 130 to the appropriate personnel within the venue. In one embodiment, the logistics application 126 uses a prediction from the prediction generating application 122 and compares the prediction to predictions for guest data 118. Based on configurable criteria, the logistics application 126 sends a message to appropriate personnel (or system) within the venue to adjust venue operations to better respond to or prepare for the predicted guest behavior. For example, an employee deployment system could be used for the real time deployment of venue staff, a kitchen dispatch system can ramp up food preparation in anticipation of a crowd coming by in a few minutes, etc. More generally, as noted, changes to venue operations includes increasing production of certain park goods, shifting venue employees from one predefined area of the venue to another, decreasing the production of other venue goods, coordinating venue staff breaks, changing or reconfiguring venue infrastructure, or other venue functions as would be appreciated by persons skilled in the art. In one example, the logistics application 128 sends a message to a venue entertainer in region A, telling the venue entertainer to move to region B, because the prediction generating application 122 has predicted that guest traffic is to increase in region B.

Collection devices 140_{1-N} generally represent any set of devices for collecting location data of guests in the venue. The collection devices 140_{1-N} further associate data collected at any device 140ᵢ with an individual guest. For example, the collection devices 140_{1-N} could be RFID readers configured to and read RFID tags worn by guests. When a guest enters an area of interest, the guest swipes the RFID bracelet against the RFID reader or simply pass nearby the RFID Reader. In response, the RFID reader records the current location of the guest as generally corresponding to the known location of the reader. The data collection appellation 120 can then receive (or retrieve) the collection data from the RFID readers. More generally, the reader can be a proximity reader (requiring a swipe), or a long range reader indicating the guest is within a few feet. In one embodiment, e.g., a 2.4 GHz WiFi system reads a signal broadcast by a guest over a range of several meters. Note, the larger the read range, the less precise the location information.

As another example, an application on a handheld device (e.g., a smart phone or tablet) can automatically send data to data collection application 120. Similarly, a guest could use an application or web page on a phone, (or kiosk at a venue) to “check-in” at a location within a venue.

FIG. 2 is a flowchart depicting a method 200 for predicting future gust locations using approximate string matching, according to one embodiment of the invention. As shown, the method begins at step 205 where a data collection application 120 captures data collected by the collection device 140ᵢ. For example, the data collection application 120 requests (or receives) data from an application on a mobile device of a guest. In another embodiment, guest location is recorded whenever a guest swipes an RFID wristband near an RFID reader. Other reading systems may record the presence of guest within a range of a few meters of a reading device.

At step 210, the data collection application 120 reads the data gathered from the collection device 140ᵢ and determines whether the guest is still in the venue. If so, the method 200 proceeds to step 215, where the data collection application 120 sends the data to the prediction generating application 122. On the other hand, if the guest is not in the venue, the method 200 proceeds to step 220, where the data collection application 120 sends information stored in the guest data 118 and discovered to be associated with the individual guest, to be added to the historical data set 128 in storage 108. That is, new data can be added to database P, as discussed above. As the guest moves through the venue, e.g., a text string is built representing the guest's path through the venue. Further, depending on the embodiment, a time based character may be inserted into the string to add a temporal metric to the approximate string matching techniques used to predict a future location of a guest.

FIG. 3 is a flowchart depicting a method 300 for generating a prediction for a guest, according to one embodiment of the invention. At step 305 the prediction generating application 122 creates a guest profile (or accesses a pre-existing guest profile) to store the data received from the data collection application 120. For example, the prediction application 122 could retrieve the character string generated by monitoring the guests' movement through a venue. For ease of understanding, the embodiments of the present invention described herein refer to a guest profile as a representation of a single individual, which in many embodiments is appropriate. However, a guest profile could represent groups of guests such as a family, a team, a club, tourist group and the like where the self-grouping of the individuals has a meaningful, observable affect on behavior. For example, families tend to travel together through the venue as a group. To the extent the data collection application can be associated with a group instead of or in addition to associating the data with individuals, additional behavioral predictions may become possible, and predictions may be more accurate and/or precise when using guest data that represent multiple individuals. And embodiments presented herein may readily be adapted depending on whether the guest data profile represents a single individual or a group of individuals.

At step 310, the prediction generating application 122 associates the location information to locations in the venue. For example, a map of attractions or locations, e.g., an area surrounding a park attraction. Location values within the defined region are indexed to the attraction, such that if the location data indicates that the guest is within the region, then the prediction generating application 122 records the guest as being at the attraction in the park. Similarly, if a guest passes by a RFID reader, then the guest prediction generating application 122 records an indication that the guest is at a given location associated with the reader. For example, where a guest in line for a park ride must swipe a bracelet, card, or other device in order to proceed to board the park ride.

At step 315, the prediction generating application 122 receives the current (or at least last reported) location of a guest in the park from the data collection application 120. At step 320, the prediction generating application 122 stores the location in the created guest profile. At step 325, the prediction generating application 122 determines whether there is enough information with which to generate a prediction. In one embodiment, the prediction generating application 122 determines whether enough data about the guest's prior movement is available to make a prediction of future movement (for this guest) (step 325). For example, the application 122 can wait until a guests' trajectory moving through the venue, represented by p=p₁p₂p₃ . . . pₙ, has a minimum size before making predictions. Similarly, the application 122 can periodically use the most recent X characters in the string to generate a prediction, where X can be set as a matter of preference.

At step 330, the prediction generating application 122 generates a prediction of the future location of the guest. As noted, in one embodiment, a database P can be used to predict in real time the future behavior of a guest for which a partial trajectory q=q₁q₂q₃ . . . qₙ, is available. In such a case, the application 122 finds the closest match p in the set of exemplar trajectories P for the partial trajectory q. The closest match p can then be used as the basis for predicting the locations that the guest will soon visit. This approach uses approximate or fuzzy string matching, in which a query string, in this case the partial trajectory q, is matched against substrings in a dictionary of strings, in this case the exemplar trajectories p in the database P.

Note, in one embodiment, the prediction generating application 122 generates predictions corresponding to multiple possibilities rather than to single predicted action. For example, if guest A has a 50% likelihood of traveling to region B, and a 50% likelihood of traveling to region C, based on the approximate string matches for the input partial trajectory q.

As noted, the prediction generating application 122 predicts a guest's next action in addition to the next location of the guest. For example, the prediction generating application 122 could predict that guest A in region B has a 75% likelihood to buy ice cream. In this example, the guest data 118 could contain purchase data as well as location data. The purchase data can be gathered by the collection devices 140_{1-N}. In one embodiment, guests swipe an RFID bracelet against RFID readers on the register, such that the transaction, as well as the location of the guest is recorded. In one embodiment, in addition to the approximate string matching techniques described above, other guest data be correlated to identify user actions. For example, records of retail transactions could be correlated with tracking of guest position. Further, a variety of machine learning techniques could be used to evaluate guest position and transaction data in order develop a model of expected guest behavior.

By making predictions for a large number of individual guests, based on the recorded history of past guests, the prediction generating application 122 can provide the park operator with valuable information about expected guest behavior collectively, even in the absence of detailed information about each particular guest (i.e., when the data for a particular guest is sparse).

FIG. 4 is a flowchart depicting a method 400 for enhancing guest experience at a venue by sending an incentive to the guest or improving park operations, according to one embodiment of the invention. At step 410, the incentive application 124 receives a prediction from the prediction generating application 122. In the pictured example, the prediction is of the next location of the guest. The incentive application 124 then determines whether to generate an incentive. For example, the incentive application 124 determines whether to generate an incentive based on guest congestion and/or traffic, weather, noise levels, special event status, or other operational concerns of the venue. Alternatively, the determination could account for other factors, such as a prediction that the guest will better enjoy a different area of the venue a determination of whether the prediction will likely change behavior of the guest, a cost-benefit analysis of the type of incentive necessary to motivate a guest, a determination of current guest traffic at a given location, a user-configurable parameter such as a level of desire to promote a new attraction, etc., and/or any combination of these factors.

At step 420, the incentive application 124 determines whether the number of other guests in the predicted location exceeds a specified count. In one embodiment, the incentive application 124 stores predictions sent to it by prediction generating application 122 and determines the total number of guests predicted to be in a given area by searching the stored predictions. Note, in one embodiment, only when the predicted attendance at a particular location exceeds a desired level does the incentive application 124 actually generate an incentive.

At step 460, the logistics application 124 uses the prediction to organize venue logistics to account for the predicted behavior of the guests. Such changes to park operations can be managed or triggered via a message. As noted, e.g., changes to venue operations to account for predicted guest movement include changing staffing, scheduling maintenance, scheduling cleaning, ensuring stock or product availability, changing productions or preparation, opening, or closing park attractions, and the like. Other examples include changing employee positions, changing work schedules, increasing/decreasing production of certain goods.

In one embodiment, if the incentive application 124 determines that the number of guests in the predicted location exceed the threshold at step 420, or that it would be desirable for any reason to reduce guest population in an area, or to increase guest population in another area, reduce traffic on a particular path, or increase traffic on another path, in step 430 the incentive application 124 determines whether the prediction is likely to change the behavior of the guest or guests.

More generally, at step 420, the application determines whether, assuming the predicted behavior occurs, is there some condition that would result (crowding, long lines, traffic congestion, etc.), where that condition will impact guest satisfaction, venue operations or some other operational goal. If so, then at step 430 the general operation is to determine whether the application “knows” of any incentive that it has available that will alter the predicted behavior in a manner that will more likely achieve the desired operational goal. Alternatively, if the there is some condition that would impact guest ratification, the application communicates this to a venue operator (or other application) to allow for venue operations to be adjusted to account for changes resulting from incentivizing multiple guests' behavior.

If the incentive application 124 determines the prediction is likely to change the behavior of the guest, the method proceeds to step 440, where the incentive application 124 sends an incentive to the guest. At step 450, the incentive application 124 provides (or otherwise makes available) the incentive and the prediction to the logistics application 126. At step 460, the logistics application 126 then organizes venue operations to facilitate the incentivized guest behavior. In some embodiments, if the incentive application 124 determines at step 430 that the incentive is unlikely to produce a desired effect, the incentive application 124 refrains from generating an incentive.

In one embodiment, the prediction generating application 122 provides (or otherwise makes available) the prediction to venue personnel or to incentive application 124. The incentive application 124 can send an incentive to the guest. Additionally the logistics application 126 can send a message to appropriate venue personnel (or other systems configured to manage ongoing venue operations).

FIG. 5 is a simplified representation 500 of a theme park with regions 505, 510, 515 and 520, locations 525, 530, 535 and 540 (corresponding to attractions, concessions, stages and the like), and routes 545, 550, 555, 560, 565 and 570 between the locations (e.g., paths, walkways, sidewalks and the like). Assume that the map 500 is passed to the prediction generating application 122. For example, if two walkways travel only from location A to location B, the walkways may both be mapped to a single route. GPS coordinates received from the collection device 140ᵢ within a radius of location 530 are be mapped to the location 530.

FIG. 6 is a map 600 showing a trip of a guest through the theme park, according to one embodiment of the invention. The map 600 is composed of four regions: region 605, region 610, region 615, and region 620. In the trip shown, the guest starts at the park entrance (location 625) at time T1, travels along route 645 to reach the roller coaster (location 630) at time T2, and then travels along route 650 to Ferris wheel (location 640) at time T3. The guest then completes his trip along route 655 to exit the park. The movement of the guest through the park is tracked by data collection devices 660, 665, 670, 676, 680, 685, 690, and 690. For example, as described above, the data collection devices can be RFID readers that the guest interacts with via swiping of an RFID bracelet. The dotted lines shown represent possible paths the guest could have traveled. For example, at time T1, the guest could have traveled to the water slide (location 635). Instead, the guest opted to go to the roller coaster. At time T2, the guest is incentivized to influence the guest to choose to go to Ferris wheel (location 640) rather than to the water slide (location 635). As discussed above, this incentive may have been sent to the mobile device of the guest, e.g., as an SMS text message.

Advantageously, guest movement tracked from location-to-location within a venue is used to learn patterns of guest behavior and make predictions for a current guest population using approximate string matching. As guests move through the venue, predictions for future movement are used to adjust park operations to better serve a guest population. In one embodiment, location information for the guests may be obtained using a variety of approaches, e.g., RFID tags, Wi-fi signal readers, GPS systems, mobile phones, location check-in, etc.

Because the location data for a given guest can be incomplete, the resulting dataset is said to be “sparse.” That is, the location data for a given guest may have gaps between subsequent observations of that guest's location, and the gaps may differ from guest to guest. Nevertheless, the available string data for a guest is evaluated, e.g., using approximate string matching techniques, to identify the most probable path a guest will take based on their prior path, when compared to strings representing other paths. Of course a variety of string matching and/or machine learning techniques could be used to evaluate the trajectory of a given guest. Further, in addition to location data, other information can be used to help predict guest behavior. For example, the strings could include a temporal dimension representing how much time has elapsed between one measured position of a guest and another Other data that can be incorporated into the string matching techniques includes, e.g., transaction or other activity data time to move of day, day of week, size of guest party, age of party members, changes in park attractions, etc.

Over time, patterns of past guest behavior can be used to predict the expected behavior of current guests. By predicting the behavior of a plurality of current guests, current operations can be adjusted to better serve guests based on the predictions. For example, a park operator can adapt to expected guest behavior by changing staffing, scheduling maintenance, scheduling, cleaning, ensuring stock or product availability, and the like. Further, at least in some cases, an operator can attempt to alter guest behavior in ways that help operations or help improve guest experience. For example, by informing guests that a particular attraction is crowded (or not), the movement through the venue can be changed and guests who might otherwise have a poor experience waiting in line can visit attractions without a wait. Further still, in addition to providing status information, in some cases, a guest is incentivized to change their behavior. Returning to the previous example, a message could be sent to a guest offering a discounts for or other form of incentives to change behavior from a predicted action (e.g., visiting a crowded attraction) to another action (stopping at a restaurant for a discounted snack).

While the foregoing is directed to embodiments of the present invention, other and further embodiments of the invention may be devised without departing from the basic scope thereof, and the scope thereof is determined by the claims that follow.

What is claimed is:

1. A method for managing venue operations based on predictions of guest behavior, the method comprising,
generating, from historical guest movement data identifying guest locations within the venue, patterns of guest movement within the venue;
obtaining, for a plurality of current guests visiting the venue, data specifying observed locations of the plurality of current guests within the venue;
predicting, based on the location data and the patterns of guest movement generated from the historical guest movement data, predicted future locations within the venue for at least some of the plurality of current guests; and
adjusting venue operations based on the predicted future locations.

2. The method of claim 1, wherein adjusting venue operations comprises at least one of changing staffing levels or assignment, scheduling maintenance, scheduling cleaning, and ensuring product availability or location.

3. The method of claim 1, wherein the venue is a theme park.

4. The method of claim 1, further comprising:
generating a message delivered to at least one of the plurality of current guests, wherein the message provides an incentive to visit a location within the venue other than the predicted location.

5. The method of claim 1, wherein one or more of the current guests correspond to a single individual visiting the venue.

6. The method of claim 1, wherein one or more of the current guests correspond to a group of two or more individuals visiting the venue.

7. The method of claim 1, wherein the data specifying observed locations of at least a first one of the plurality of current guests within the venue is captured via RFID readers disposed throughout the venue and a RFID tag possessed by the first guest.

8. The method of claim 1, wherein the data specifying observed locations of a first one of the plurality of current guests is captured via a GPS receiver possessed by the first guest.

9. The method of claim 1, wherein the predicting of the predicted future locations within the venue for at least some of the plurality of current guests is performed using approximate string matching.

10. A method of motivating behavior within a venue, the method comprising:
for a first entity comprising at least one individual, correlating the entities current actual behavior with past behavior records of other entities to identify correlated past behavior records;
using the correlated past behavior records, predicting at least one future behavior of the first entity; and
determining whether the predicted future behavior is consistent with operational goals of the venue; and
when the predicted future behavior is inconsistent with the operational goals, taking a responsive action comprising one or more actions selected from the group consisting of: providing a motivation to change the first entities future behavior such that it is different from the predicted behavior and changing some operational characteristic of the venue such that the predicted future behavior is consistent with operational goals of the venue.

11. A computer-readable storage medium storing one or more application programs, which, when executed on a computer perform an operation for managing venue operations based on predictions of guest behavior, the operation comprising:
generating, from historical guest movement data identifying guest locations within the venue, patterns of guest movement within the venue;
obtaining, for a plurality of current guests visiting the venue, data specifying observed locations of the plurality of current guests within the venue;
predicting, based on the location data and the patterns of guest movement generated from the historical guest movement data, predicted future locations within the venue for at least some of the plurality of current guests; and
adjusting venue operations based on the predicted future locations.

12. The computer-readable storage medium of claim 11, wherein adjusting venue operations comprises at least one of changing staffing levels or assignment, scheduling maintenance, scheduling cleaning, and ensuring product availability or location.

13. The computer-readable storage medium of claim 11, wherein the venue is a theme park.

14. The computer-readable storage medium of claim 11, wherein the operation further comprises:
generating a message delivered to at least one of the plurality of current guests, wherein the message provides an incentive to visit a location within the venue other than the predicted location.

15. The computer-readable storage medium of claim 11, wherein one or more of the current guests correspond to a single individual visiting the venue.

16. The computer-readable storage medium of claim 11, wherein one or more of the current guests correspond to a group of two or more individuals visiting the venue.

17. The computer-readable storage medium of claim 11, wherein the data specifying observed locations of at least a first one of the plurality of current guests within the venue is captured via RFID readers disposed throughout the venue and a RFID tag possessed by the first guest.

18. The computer-readable storage medium of claim 11, wherein the data specifying observed locations of a first one of the plurality of current guests is captured via a GPS receiver possessed by the first guest.

19. The computer-readable storage medium of claim 11, wherein guest movement data is represented as strings of consecutive locations and the predicting of the predicted future locations within the venue for at least some of the plurality of current guests is performed using approximate string matching.

20. A system, comprising:
a processor; and
a memory storing one or more application programs, which, when executed on the processor perform an operation for managing venue operations based on predictions of guest behavior, the operation comprising:
generating, from historical guest movement data identifying guest locations within the venue, patterns of guest movement within the venue,
obtaining, for a plurality of current guests visiting the venue, data specifying observed locations of the plurality of current guests within the venue,
predicting, based on the location data and the patterns of guest movement generated from the historical guest movement data, predicted future locations within the venue for at least some of the plurality of current guests, and
adjusting venue operations based on the predicted future locations.

21. The system of claim 20, wherein adjusting venue operations comprises at least one of changing staffing levels or assignment, scheduling maintenance, scheduling cleaning, and ensuring product availability or location.

22. The system of claim 20, wherein the venue is a theme park.

23. The system of claim 20, wherein the operation further comprises:
generating a message delivered to at least one of the plurality of current guests, wherein the message provides an incentive to visit a location within the venue other than the predicted location.

24. The system of claim 20, wherein one or more of the current guests correspond to a single individual visiting the venue.

25. The system of claim 20, wherein one or more of the current guests correspond to a group of two or more individuals visiting the venue.

26. The system of claim 20, wherein the data specifying observed locations of at least a first one of the plurality of current guests within the venue is captured via RFID readers disposed throughout the venue and a RFID tag possessed by the first guest.

27. The system medium of claim 20, wherein the data specifying observed locations of a first one of the plurality of current guests is captured via a GPS receiver possessed by the first guest.

28. The system medium of claim 20, wherein guest movement data is represented as strings of consecutive locations and time intervals and the predicting of the predicted future locations within the venue for at least some of the plurality of current guests is performed using approximate string matching.
